(19) United States
(12) Patent Application Publication
(10) Pub. No.: US 2015/0067314 A1
(43) Pub. Date: Mar. 5, 2015

(54) SECURE FIRMWARE FLASH CONTROLLER

(71) Applicants: Timothy J. Strauss, Granger, IN (US); Thomas Jew, Austin, TX (US); Kelly K. Taylor, Austin, TX (US)

(72) Inventors: Timothy J. Strauss, Granger, IN (US); Thomas Jew, Austin, TX (US); Kelly K. Taylor, Austin, TX (US)

(21) Appl. No.: 14/015,889

(22) Filed: Aug. 30, 2013

(51) Int. Cl. G06F 21/57

(52) U.S. Cl. CPC G06F 21/572
USPC 713/2; 713/1

(57) ABSTRACT

A microcontroller that includes a secure firmware flash controller is provided. The secure firmware flash controller utilizes a hardware assisted boot sequence that performs a firmware code validation. If the firmware code fails validation for any reason, the firmware flash controller locks out access to the firmware RAM and firmware flash controller, and passes control back to the microcontroller for further measures that are protected by security protocols on the microcontroller.

### BACKGROUND

1. Field

This disclosure relates generally to microcontroller security, and more specifically, to a secure microcontroller firmware flash controller subsystem.

2. Related Art

Microcontrollers are embedded in a variety of systems to control various operational aspects of those systems. In automobiles, for example, microcontrollers are used to adaptively control engine functionality, on-board entertainment systems, safety locks, windows, and the like. Proper functioning of the systems controlled by embedded microcontrollers is necessary not only for continued good operations of the vehicle, but also for the safety of the passengers.

Microcontrollers store their operational code in the form of firmware. Historically, microcontroller firmware was stored in one-time programmable memories such as a ROM. While storing firmware in a one-time programmable memory provided a long-lasting image of the firmware, such a method was also inflexible should there be desired modifications to the firmware. More modern microcontrollers store firmware in a flash memory. A flash memory subsystem stores firmware code and can retrieve that firmware code upon a reset of the microcontroller system. The flash memory subsystem may also provide a mechanism to initially store the firmware in the flash memory. While flash memory provides greater flexibility to a manufacturer of those systems incorporating the microcontroller, that same flexibility presents potential security holes that may be exploited.

In certain microcontrollers having firmware stored in a flash memory subsystem, if a check of the validity of stored firmware code fails, then the firmware flash controller defaults to a firmware input mode. That is, the default for a failure of a check on stored firmware is that new firmware should be entered. The firmware flash controller may enter a state in which the firmware flash controller waits for input from a special port (e.g., a JTAG port), including a passkey. Once a proper passkey is provided, the firmware code can be modified or replaced. Since a firmware code check failure can be triggered by voltage and temperature fluctuations caused by hacker manipulation, this wait mode provides a security hole that needs to be addressed.

### BRIEF DESCRIPTION OF THE DRAWINGS

The present invention may be better understood, and its numerous objects, features, and advantages made apparent to those skilled in the art by referencing the accompanying drawings.

FIG. 1 is a simplified block diagram illustrating an example of a data processing system usable with embodiments of the present invention.

FIG. 2 is a simplified block diagram illustrating details of flash memory subsystem, in accordance with embodiments of the present invention.

FIG. 3 is a simplified flow diagram illustrating one example of a process executed by a flash memory subsystem during a system reset, in accordance with embodiments of the present invention.

The use of the same reference symbols in different drawings indicates identical items unless otherwise noted. The figures are not necessarily drawn to scale.

### DETAILED DESCRIPTION

A microcontroller that includes a secure firmware flash controller is provided. The secure firmware flash controller utilizes a hardware assisted boot sequence that performs a firmware code validation. If the firmware code fails validation for any reason, the firmware flash controller locks out access to the firmware RAM and firmware flash controller, and passes control back to the microcontroller for further measures that are protected by security protocols on the microcontroller.

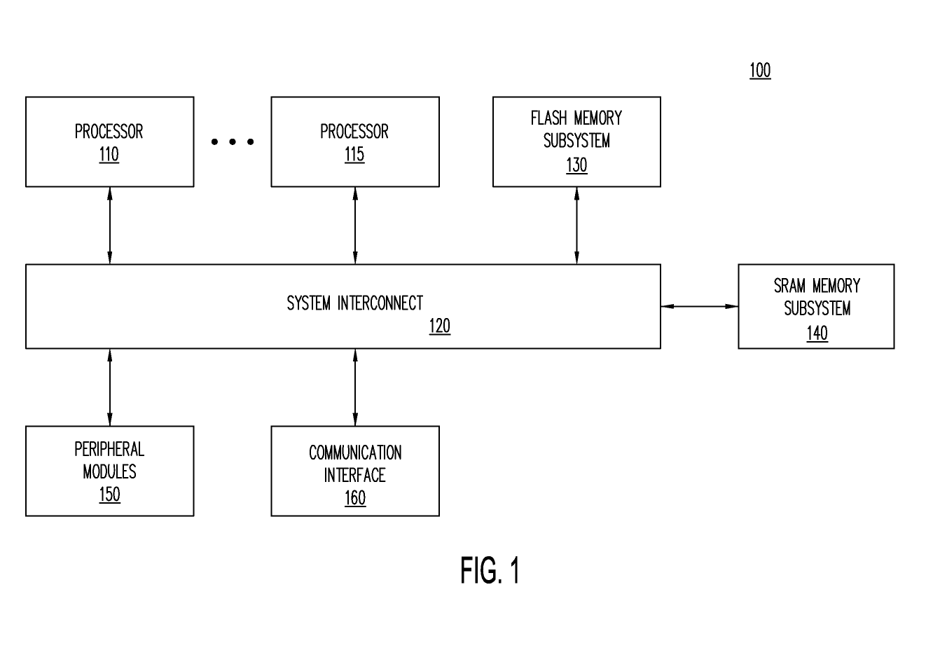

FIG. 1 is a simplified block diagram illustrating an example of a data processing system 100 usable with embodiments of the present invention. Data processing system 100 can be, for example, a microcontroller or microprocessor system. Data processing system 100 includes one or more processor cores 110 and 115, a system interconnect bus 120, a flash memory subsystem 130, and SRAM memory subsystem 140, peripheral modules 150, and communication interfaces 160. Each component of data processing system 100 can communicate with each other through at least system interconnect bus 120, and can be communicatively coupled with one or more other components by a bus other than system interconnect bus 120 (not shown).

Flash memory subsystem 130 stores at least the firmware code that controls operational behavior of data processing system 100. As will be discussed more fully below, flash memory subsystem 130 includes several subcomponents, including a firmware flash controller that allows for input of the firmware code for storage, as well as determining continued validity of the stored firmware code upon retrieval. SRAM memory subsystem 140 allows for access to and from system memory by, for example, processors 110 and 115. SRAM memory subsystem 140 can include, for example, a memory cache as well as hardware controllers to access SRAM memory elements. Peripheral modules 150 and communication interfaces 160 provide mechanisms by which data processing system 100 can communicate with and interact with elements external to data processing system 100.

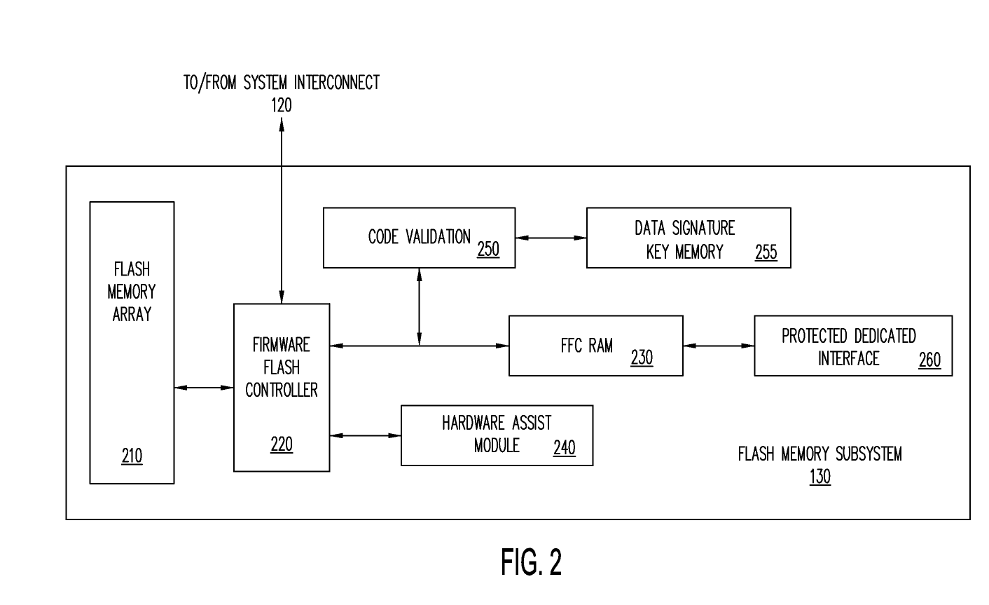

FIG. 2 is a simplified block diagram illustrating details of flash memory subsystem 130, in accordance with embodiments of the present invention. As discussed above, flash memory subsystem 130 is configured to store, access, and verify firmware code used to control operational behavior of data processing system 100. Flash memory subsystem 130 includes a flash memory array 210 that can store the firmware code. Typically, flash memory array 210 will include a plurality of one of NOR or NAND memory arrays depending on the application. Flash memory array 210 is communicatively coupled to firmware flash controller 220, which is configured to access memory locations within flash memory array 210 and provide information from those memory locations to, for example, FFC RAM 230. Firmware flash controller 220 is also configured to provide information from FFC RAM 230 to system interconnect 120, and to receive requests for information from system interconnect 120. FFC RAM 230 is configured to store data retrieved from flash memory array 210 during flash memory retrieval operations. Flash memory retrieval operations such as these typically will occur during system reset, such as boot up during power initialization or a system crash.

Firmware flash controller 220 is also communicatively coupled with hardware assist module 240. Hardware assist module 240 can be a hardware state machine that can manage the transfer of data (e.g., firmware code) from flash memory array 210 to FFC RAM 230. In an alternative embodiment, hardware assist module 240 can be implemented as a ROM code executed in synthesized logic. During the course of transferring firmware code, for example, hardware assist module 240 can also perform tasks related to generating a data signature of the firmware code. Such a data signature can take a variety of forms, depending upon the nature of the application and the type of security desired to be implemented. For example, a cyclic redundancy check (CRC) signature can be generated. Alternatively, as another example, a multiple input shift register (MISR) signature can be generated. Each type of data signature can be generated by dedicated hardware provided for that task. Through the use of hardware to both transfer data from the flash memory array to the FFC RAM, and perform signature generation, the ability to successfully externally attack these tasks is reduced.

Subsequent to transfer of firmware code from flash memory array 210 to FFC RAM 230 and generation of the data signature related to the firmware code, code validation module 250 can perform tasks to confirm that the transferred firmware code has not been tampered with or is otherwise invalid. Such code validation can be performed by comparing the generated data signature with a data signature key corresponding to the firmware code when the firmware code was first instantiated in the flash memory subsystem, in which the data signature key is stored in data signature key memory 255. If the firmware code passes validation, then firmware flash controller 220 can permit execution of the firmware loaded into FFC RAM 230 by processors in data processing system 100 (e.g., a microcontroller unit) and place the data processing system in a ready state. If the firmware code fails validation, then firmware flash controller 220 can be stopped from permitting execution of the firmware, block execution of any test modes of the firmware flash controller, and subsequently pass control back to processors of the data processing system and place the data processing system in a locked state. Once in a locked state, access to the flash memory subsystem can only be had by progressing through a variety of security protocols implemented by the data processing system. Such security protocols can include, for example, a variety of passwords, lockout, and the like.

Flash memory subsystem 130 can also provide for input of firmware code during initialization of data processing system 100. If upon system reset, firmware flash controller 220 determines through the validation process that either invalid or nonexistent firmware code is stored in flash memory array 210, then, as discussed above, the data processing system is placed in a locked state and control is passed back to the data processing system. The data processing system implements a series of security protocols that, once traversed, will allow for input of firmware code. At that point, firmware code can be provided through protected dedicated interface 260 to FFC RAM 230. Protected dedicated interface 260 can take a variety of forms, depending upon the application. Once the firmware code is provided to FFC RAM 230, firmware flash controller 220 can transfer the firmware code to locations within flash memory array 210. During this transfer, hardware assist module 240 can analyze the transferred code and generate a data validation key corresponding to the firmware code and store that data validation key in a location accessible by code validation module 250 for future validation tasks associated with access of the firmware code (e.g., data validation key memory 255).

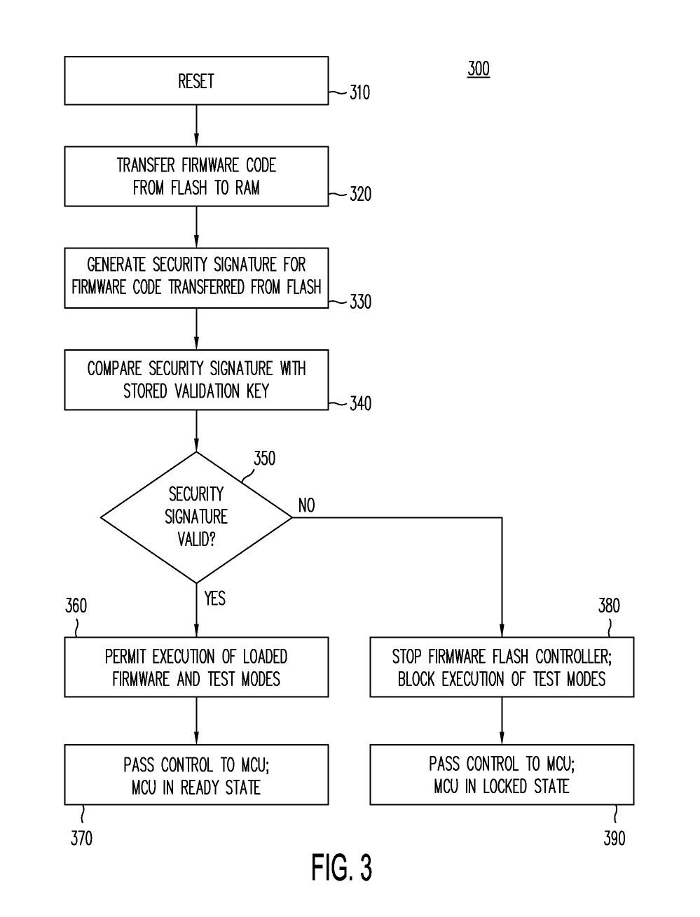

FIG. 3 is a simplified flow diagram illustrating one example of a process executed by a flash memory subsystem during a system reset, in accordance with embodiments of the present invention. Flow 300 begins with a system reset (310). System reset operations can occur, as discussed above, during system reboots, power initialization, recovery from system crashes, and the like. Flash memory subsystem 130 will receive an indication that a system reset is occurring, typically from a processor (e.g., processor 110 or 115), and begin reset operations.

Upon receiving a system reset indication, a firmware flash controller (e.g., firmware flash controller 220) can begin transfer of firmware code from a flash memory array to a storage RAM (320). As the firmware code is transferred from the flash memory array to the storage RAM, a security signature can be generated for that code (330). As discussed above, generation of the security signature can be performed with the assistance of a hardware assist module (e.g., hardware assist module 240). Once the firmware code has been transferred to the storage RAM, the generated security signature is checked against a stored data validation key (340). As discussed above, the security signature and the data validation key can be generated by a variety of methods, including cyclic redundancy check and multiple input shift register.

A determination is made whether the generated security signature is valid, that is, there is a match with the stored data validation key (350). If the security signature is valid, then the firmware flash controller can permit execution of the loaded firmware and approve operation of test modes for the system (360). Finally the firmware flash controller can pass control of the system back to the data processing system (e.g. the microcontroller unit) and place the data processing system in a ready state (370). If the security signature is not valid, then the firmware flash controller can stop operations and block execution of test modes of the system (380). Subsequently, control of the system can be passed back to the data processing system and placed the data processing system in a locked state (390).

In either the ready state or the locked state, security protocols for the data processing system are in effect. That is, should an operator wish to make changes to the stored firmware or other operational changes, the operator will be required to satisfy all security measures that are implemented for the system, if available. If the operator cannot satisfy those security measures, then the operator will not be able to change firmware code and the like. In this manner, embodiments of the present invention provide a significant improvement over traditional firmware-based data processing systems that can provide access to firmware without passing through security measures.

By now it should be appreciated that there has been provided a flash memory subsystem that includes a flash memory array storing firmware code executable by a processor coupled to the flash memory subsystem, and a firmware flash controller coupled to the flash memory array and a random access memory (RAM). The firmware flash controller is configured to copy the firmware code from the flash memory array to the RAM. In response to a determination that the copied firmware code is a valid copy, the firmware flash controller is further configured to provide the firmware code to the processor for execution. In response to a determination that the copied firmware code is an invalid copy, the firmware flash controller does not provide the firmware code to the processor and places the processor in a locked state.

In one aspect of the above embodiment, the flash memory subsystem further includes a hardware assist module that is coupled to the firmware flash controller. The hardware assist module is configured to generate a security signature from the firmware code concurrent with the copying of the firmware code from the flash memory array to the RAM. In a further aspect, the security signature is generated using one of cyclic redundancy check or multiple input shift register. In another further aspect, the flash memory subsystem further includes a code validation module coupled to the firmware flash controller and the RAM. The code validation module is configured to receive the security signature, compare the security signature with a stored validation key, determine that the copied firmware code is valid in response to the security signature matching the stored validation key, determine that the copied firmware code is invalid in response to the security signature not matching the stored validation key, and provide results of said determining to the firmware flash controller. The stored validation key is generated when the firmware code is initially stored in the flash memory subsystem.

In another aspect of the above embodiment, the firmware flash controller is configured to halt the firmware flash controller in response to the determination that the copied firmware code is an invalid copy. In yet another aspect of the above embodiment, said placing the processor in a locked state includes executing one or more security protocols limiting access to the processor and the flash memory subsystem.

Another embodiment of the present invention provides a method for restarting a microcontroller device. The method includes: generating a security signature for firmware code accessed by a flash memory subsystem; permitting execution of the firmware code by a processor of the microcontroller device and passing control from the flash memory subsystem to the microcontroller device in response to determining that the security signature for the firmware code matches a stored validation key; and, blocking execution of the firmware code by the processor, placing the microcontroller in a locked state, and passing control from the flash memory subsystem to the microcontroller device in response to determining that the security signature for the firmware code does not match the stored validation key.

One aspect of the above embodiment further includes receiving a reset signal at the flash memory subsystem, and performing said generating the security signature and said determining in response to the reset signal. A further aspect includes transferring the firmware code from a flash memory array accessible by the flash memory subsystem to a random access memory (RAM) of the flash memory subsystem in response to the reset signal, and performing said generating the security signature during said transferring the firmware code. Another further aspect provides for the reset signal to be received in response to a reboot of the microcontroller device.

Another aspect of the above embodiment provides for the generating of the security signature for the firmware code to be performed by a hardware assist module configured to perform one of a cyclic redundancy check or a multiple input shift register check of the firmware code. In another aspect of the above embodiment, the generating, the determining the matching of the security signature, the permitting execution, and the blocking execution are performed in association with a firmware flash controller of the flash memory subsystem. In a further aspect, the determining the matching of the security signature is performed by a code validation module communicatively coupled to the firmware flash controller. Another aspect of the above embodiment further includes storing the firmware code in a flash memory array associated with the flash memory subsystem, and generating the stored validation key during the storing of the firmware code.

Another embodiment of the present invention provides a microcontroller unit that includes a system interconnect, one or more processors communicatively coupled to the system interconnect, and a flash memory subsystem communicatively coupled to the system interconnect. The flash memory subsystem includes a flash memory array storing firmware code executable by the one or more processors, and a firmware flash controller coupled to the flash memory array and a random access memory (RAM) associated with the flash memory subsystem. The firmware flash controller is configured to: copy the firmware code from the flash memory array to the RAM; provide the firmware code to one or more of the processors for execution in response to a determination that the copied firmware code is a valid copy; and not provide the firmware code to the processors and place the microcontroller unit in a locked state in response to a determination that the copied firmware code is an invalid copy.

In one aspect of the above embodiment, the flash memory subsystem further includes a hardware assist module that is coupled to the firmware flash controller, and is configured to generate a security signature from the firmware code concurrent with the copying of the firmware code from the flash memory array to the RAM. In a further aspect, the security signature is generated using one of cyclic redundancy check or multiple input shift register. In another further aspect, the flash memory subsystem further includes a code validation module coupled to the firmware flash controller and the RAM. The code validation module is configured to: receive the security signature; compare the security signature with a stored validation key that is generated when the firmware code is initially stored in the flash memory subsystem; determine that the copied firmware code is valid in response to the security signature matching the stored validation key; determine that the copied firmware code is invalid in response to the security signature not matching the stored validation key; and provide results of said determining to the firmware flash controller. In another further aspect, placing the microcontroller unit in a locked stated includes the one or more processors executing one or more security protocols limiting access to the microcontroller unit and the flash memory array.

Because the apparatus implementing the present invention is, for the most part, composed of electronic components and circuits known to those skilled in the art, circuit details will not be explained in any greater extent than that considered necessary as illustrated above, for the understanding and appreciation of the underlying concepts of the present invention and in order not to obfuscate or distract from the teachings of the present invention.

Some of the above embodiments, as applicable, may be implemented using a variety of different information processing systems. For example, although FIG. 1 and the discussion thereof describe an exemplary information processing architecture, this exemplary architecture is presented merely to provide a useful reference in discussing various aspects of the invention. Of course, the description of the architecture has been simplified for purposes of discussion, and it is just one of many different types of appropriate architectures that may be used in accordance with the invention. Those skilled in the art will recognize that the boundaries between logic blocks are merely illustrative and that alternative embodiments may merge logic blocks or circuit elements or impose an alternate decomposition of functionality upon various logic blocks or circuit elements.

Thus, it is to be understood that the architectures depicted herein are merely exemplary, and that in fact many other architectures can be implemented which achieve the same functionality. In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the functionality of the above described operations merely illustrative. The functionality of multiple operations may be combined into a single operation, and/or the functionality of a single operation may be distributed in additional operations. Moreover, alternative embodiments may include multiple instances of a particular operation, and the order of operations may be altered in various other embodiments.

Although the invention is described herein with reference to specific embodiments, various modifications and changes can be made without departing from the scope of the present invention as set forth in the claims below. For example, a variety of security checksum calculation methods can be used to generate and check signatures of the firmware code. Accordingly, the specification and figures are to be regarded in an illustrative rather than a restrictive sense, and all such modifications are intended to be included within the scope of the present invention. Any benefits, advantages, or solutions to problems that are described herein with regard to specific embodiments are not intended to be construed as a critical, required, or essential feature or element of any or all the claims.

The term “coupled,” as used herein, is not intended to be limited to a direct coupling or a mechanical coupling.

Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles.

Unless stated otherwise, terms such as “first” and “second” are used to arbitrarily distinguish between the elements such terms describe. Thus, these terms are not necessarily intended to indicate temporal or other prioritization of such elements.

What is claimed is:

1. A flash memory subsystem comprising:
a flash memory array storing firmware code executable by a processor coupled to the flash memory subsystem;
a firmware flash controller, coupled to the flash memory array and a random access memory (RAM), and configured to
copy the firmware code from the flash memory array to the RAM,
in response to a determination that the copied firmware code is a valid copy, providing the firmware code to the processor for execution, and
in response to a determination that the copied firmware code is an invalid copy, not providing the firmware code to the processor and placing the processor in a locked state.

2. The flash memory subsystem of claim 1 further comprising:
a hardware assist module, coupled to the firmware flash controller, and configured to generate a security signature from the firmware code concurrent with said copying of the firmware code from the flash memory array to the RAM.

3. The flash memory subsystem of claim 2 wherein the security signature is generated using one of cyclic redundancy check or multiple input shift register.

4. The flash memory subsystem of claim 2 further comprising:
a code validation module, coupled to the firmware flash controller and the RAM, and configured to
receive the security signature,
compare the security signature with a stored validation key, wherein
the stored validation key is generated when the firmware code is initially stored in the flash memory subsystem,
determine that the copied firmware code is valid in response to the security signature matching the stored validation key,
determine that the copied firmware code is invalid in response to the security signature not matching the stored validation key, and
provide results of said determining to the firmware flash controller.

5. The flash memory subsystem of claim 1 wherein the firmware flash controller is further configured to halt the firmware flash controller in response to the determination that the copied firmware code is an invalid copy.

6. The flash memory subsystem of claim 1 wherein said placing the processor in a locked state comprises executing one or more security protocols limiting access to the processor and the flash memory array.

7. A method for restarting a microcontroller device, the method comprising:
generating a security signature for firmware code accessed by a flash memory subsystem;
in response to determining that the security signature for the firmware code matches a stored validation key, permitting execution of the firmware code by a processor of the microcontroller device and passing control from the flash memory subsystem to the microcontroller device;
in response to determining that the security signature for the firmware code does not match the stored validation key, blocking execution of the firmware code by the processor, placing the microcontroller in a locked state, and passing control from the flash memory subsystem to the microcontroller device.

8. The method of claim 7 further comprising:
receiving a reset signal at the flash memory subsystem; and
performing said generating the security signature and said determining in response to the reset signal.

9. The method of claim 8 further comprising:
transferring the firmware code from a flash memory array accessible by the flash memory subsystem to a random access memory (RAM) of the flash memory subsystem in response to the reset signal; and
performing said generating the security signature during said transferring the firmware code.

10. The method of claim 8 wherein the reset signal is received in response to a reboot of the microcontroller device.

11. The method of claim 7 wherein said generating the security signature for the firmware code is performed by a hardware assist module configured to perform one of a cyclic redundancy check or a multiple input shift register check of the firmware code.

12. The method of claim 7 wherein said generating, said determining the matching of the security signature, said permitting execution, and said blocking execution are performed in association with a firmware flash controller of the flash memory subsystem.

13. The method of claim 12 wherein said determining the matching of the security signature is performed by a code validation module communicatively coupled to the firmware flash controller.

14. The method of claim 7 further comprising:
storing the firmware code in a flash memory array associated with the flash memory subsystem; and
generating the stored validation key during said storing the firmware code.

15. A microcontroller unit comprising:
a system interconnect;
one or more processors, each communicatively coupled to the system interconnect; and
a flash memory subsystem, communicatively coupled to the system interconnect, and comprising
a flash memory array storing firmware code executable by the one or more processors,
a firmware flash controller, coupled to the flash memory array and a random access memory (RAM) associated with the flash memory subsystem, and configured to
copy the firmware code from the flash memory array to the RAM,
in response to a determination that the copied firmware code is a valid copy, providing the firmware code to one or more of the processors for execution, and
in response to a determination that the copied firmware code is an invalid copy, not providing the firmware code to the processors and placing the microcontroller unit in a locked state.

16. The microcontroller unit of claim 15 wherein the flash memory subsystem further comprises:
a hardware assist module, coupled to the firmware flash controller, and configured to generate a security signature from the firmware code concurrent with said copying of the firmware code from the flash memory array to the RAM.

17. The microcontroller unit of claim 16 wherein the security signature is generated using one of cyclic redundancy check or multiple input shift register.

18. The microcontroller unit of claim 16 wherein the flash memory subsystem further comprises:
a code validation module, coupled to the firmware flash controller and the RAM, and configured to
receive the security signature,
compare the security signature with a stored validation key, wherein
the stored validation key is generated when the firmware code is initially stored in the flash memory subsystem,
determine that the copied firmware code is valid in response to the security signature matching the stored validation key,
determine that the copied firmware code is invalid in response to the security signature not matching the stored validation key, and
provide results of said determining to the firmware flash controller.

19. The microcontroller unit of claim 16 wherein said placing the microcontroller unit in a locked state comprises the one or more processors executing one or more security protocols limiting access to the microcontroller unit and the flash memory array.
